(19) United States
(12) Patent Application Publication
(10) Pub. No.: US 2013/0106040 A1
(43) Pub. Date: May 2, 2013

(54) LENS DEWAXING DEVICE

(71) Applicant: SHAO-KAI PEI, Tu-Cheng (TW)

(72) Inventor: SHAO-KAI PEI, Tu-Cheng (TW)

(73) Assignee: HON HAI PRECISION INDUSTRY CO., LTD., Tu-Cheng (TW)

(21) Appl. No.: 13/337,176

(22) Filed: Dec. 26, 2011

(30) Foreign Application Priority Data
Oct. 27, 2011 (TW) 100139233

(51) Int. Cl. B23Q 3/18

(52) U.S. Cl. 269/58

(57) ABSTRACT

A lens dewaxing device includes a platform, a heating plate, a first linear actuator, a second linear actuator, and an operating plate. The platform includes a base and a support positioned on the base. The heating plate is positioned on the base. The first linear actuator includes a first rail fixed to the support, in parallel with the heating plate, and a first slider slidably riding on the first rail. The second linear actuator includes a second rail and a second slider slidably riding on the second rail. The second slider is connected to the first slider in such a way that the second rail is perpendicular to the heating plate. The operating plate is fixed to the second rail at an end far from the first linear actuator and in parallel with the heating plate.

### BACKGROUND

1. Technical Field

The present disclosure relates to lenses and, particularly, to a lens dewaxing device for automatically removing wax from lenses which are combined by the wax.

2. Description of Related Art

To increase efficiency, glass substrates are stacked and combined together using wax and ground into lenses. As such, after the grinding, the wax needs to be removed to separate the lenses, which is typically realized by human operations at present. However, to remove the wax, a high temperature above 60 degrees is required, which may be harmful to operators.

Therefore, it is desirable to provide a lens dewaxing device, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric schematic view of a lens dewaxing device, according to an embodiment.

FIG. 2 is a partial exploded view of the lens dewaxing device of FIG. 1.

FIGS. 3-8 are planar schematic views showing various states of the lens dewaxing device.

### DETAILED DESCRIPTION

Embodiments of the present disclosure will now be described in detail with reference to the drawing.

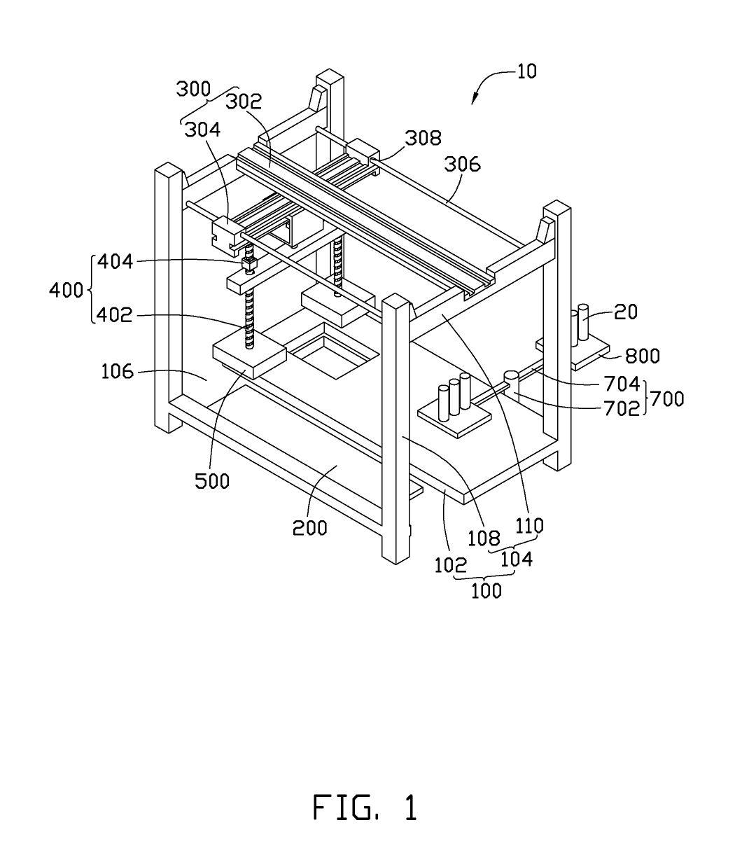

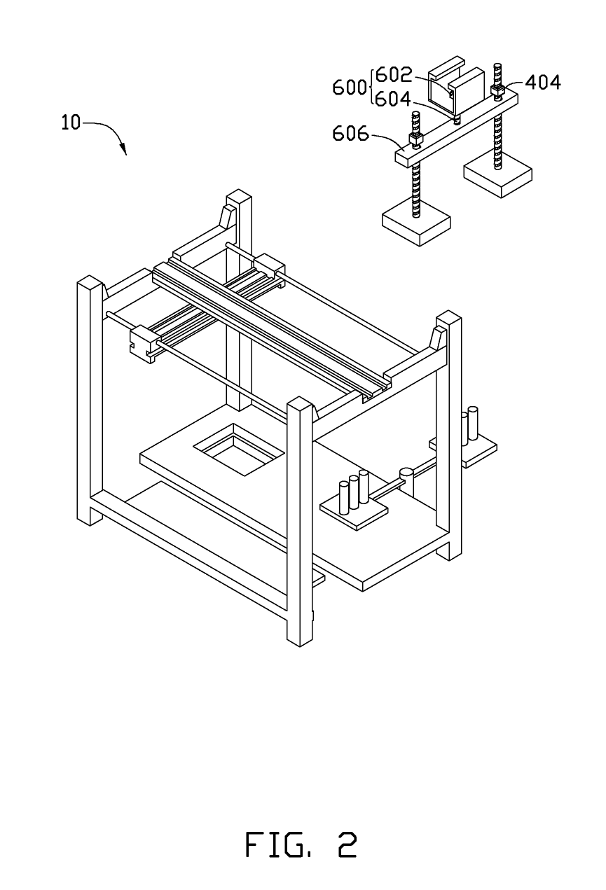

Referring to FIGS. 1 and 2, a lens dewaxing device 10, according to an embodiment, includes a platform 100, a heating plate 200, a first linear actuator 300, two second linear actuators 400, two operating plates 500, and a first rotational motor 600, a second rotational motor 700, and two feeding plates 800.

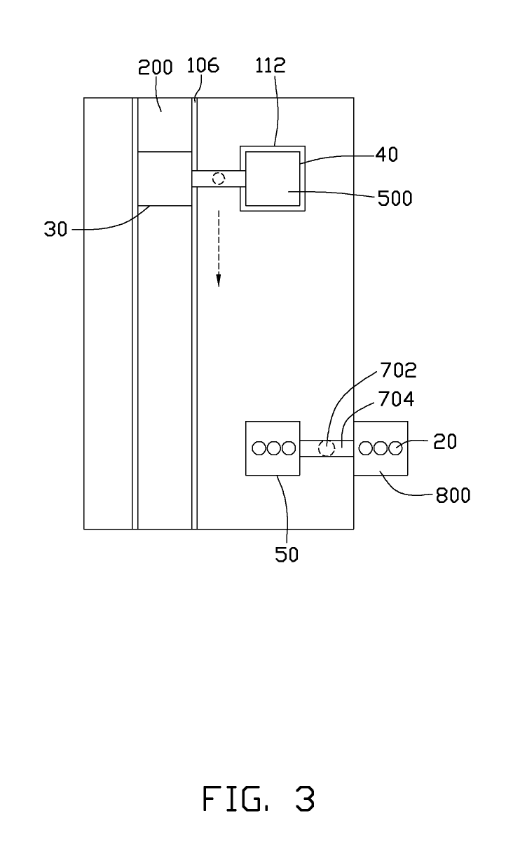

The platform 100 includes a base 102 and a support 104 positioned on the base 102. The base 102 is rectangular and defines a rectangular opening 106. The lengthwise direction of the opening 106 is substantially parallel to that of the base 102. The support 104 includes four vertical rods 108 and two horizontal rods 110. The four vertical rods 108 are perpendicularly connected to the base 102, at four corners, such that the base 102 is positioned at one end of the four vertical rods 108. The two horizontal rods 110 are positioned at the other end of the four vertical rods 108 and parallel with each other. Two ends of each horizontal rod 110 connect two of the vertical rods 108. The base 102 also defines a groove 112 (see FIGS. 3-5 and 7) for receiving molten wax. The groove 112 is also rectangular, and the lengthwise direction of the groove 112 is substantially parallel to that of the base 102. The groove 112 is set at a lengthwise end of the base 102, beside the opening 106.

The heating plate 200 is positioned on the base 102. In detail, the heating plate 200 is also rectangular and received in the opening 106 such that the lengthwise direction of the heating plate 200 is substantially parallel to that the lengthwise direction of the opening 106. The heating plate 200 is made of metal and can be electrically heated.

The first linear actuator 300, such as a linear motor, includes a first rail 302 and a first slider 304. The first rail 302 is fixed to the support 104 and is in parallel with the heating plate 200. The first slider 304 slidably rides on the first rail 302. The first linear actuator 300 is configured for driving the first slider 304 to slide on the first rail 302. In detail, the first rail 302 connects central portions of the two horizontal rods 110 together. The lengthwise direction of the first rail 302 is parallel to the lengthwise direction of the heating plate 200. The first linear actuator 300 further includes two guiding rods 306, positioned across the two horizontal rods 110 and at two sides of the first rail 302. The lengthwise directions of the guiding rods 306 are substantially parallel to the lengthwise direction of the first rail 302. The first slider 304 is a rectangular block that defines two guide holes 308 at two lengthwise ends. The two guiding rods 306 slidably run through the respective guiding holes 308.

The first rotational motor 600 includes a connection body 602 connected to the first slider 304, and a first rotor 604 protruding from the connection body 602, and a first connecting plate 606 with a central potion thereof connected to the first rotor 604. The first rotational motor 600 is configured for driving the first rotor 604 along with the first connecting plate 606 to rotate relative to the connection body 602. The lengthwise direction of the first rotor 604 is substantially perpendicular to the lengthwise directions of the first slider 304 and the first rail 302. The first connecting plate 606 is rectangular and is set in such a way that the lengthwise direction of the first connecting plate 606 is substantially perpendicular to the lengthwise direction of the first rotor 604.

The second linear actuators 400, may be, for example, ball screws, and each actuator 400 includes a second rail 402 and a second slider 404. The second slider 404 slidably rides on the second rail 402. The second sliders 404 are fixed to the first connecting plate 606, at two sides of the first rotor 604, such that the second rails 402 are substantially perpendicular to the heating plate 200. The second linear actuators 400 are configured for driving the second sliders 404 to slide on the second rails 402 such that the second rail 402 moves in a direction substantially perpendicular to the heating plate 200.

The operating plates 500 are fixed to the second rails 402, at an end far from the connecting plate 606 and in parallel with the heating plate 200. Each operating plate 500 is similar to the groove 112 in shape but smaller.

The second rotational motor 700 includes a second rotor 702 and a second connecting plate 704 with a central portion thereof connected to an end of the second rotor 702. The second rotor 702 is positioned beside the base 102, adjacent to a corner of the base 102 that is far from the opening 106 and the groove 112. The lengthwise direction of the second rotor 702 is substantially perpendicular to the base 102. The second connecting plate 704 is elongated and extends along a direction that is substantially parallel to the base 102.

Central portions of the feeding plates 800 are connected to two respective ends of the connecting plate 704. The feeding plates 800 are similar to the operating plates 500 in shape and size and arranged in parallel with the base 102.

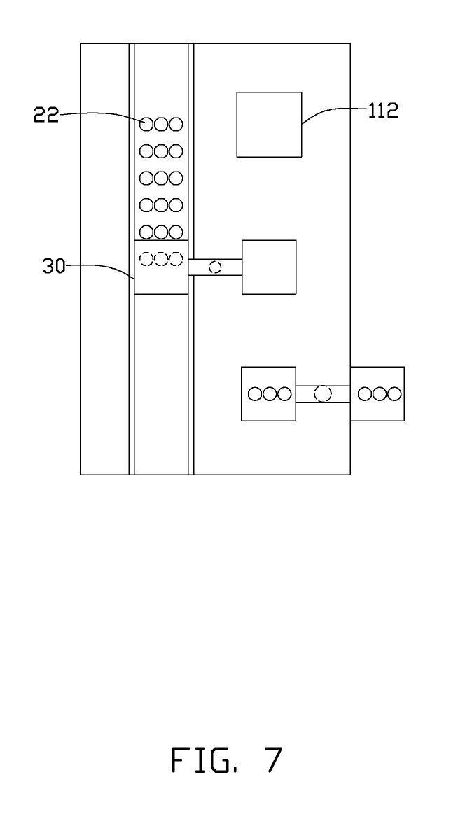

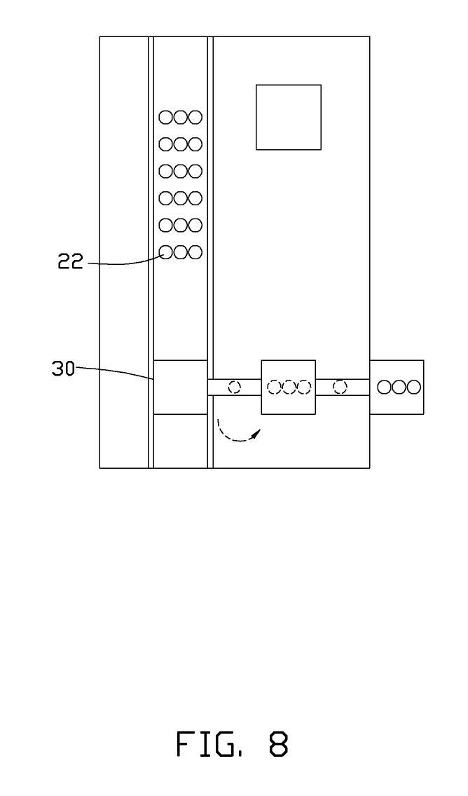

Referring to FIG. 3, in operation, the heating plate 200 is heated and the molten wax is stored in the groove 112. The first linear actuator 300 and the first rotational motor 600 cooperatively drive one of the operating plates 500 to a first position 30 where the operating plate 500 faces the heating plate 200 directly and the other operating plate 500 to a second position 40 where the operating plate 500 faces the groove 112 directly. The second linear actuator 400 corresponding to the operating plate 500 at the second position 40 drives the operating plate 500 at the second position 40 to dip into the molten wax and then move back. A number of, e.g., three, cylinders 20, each of which is comprised of a number of lenses 22 (see FIGS. 7-8) stacked and combined together by wax is placed on each of the feeding plates 800, manually or by an automatic feeding device. The second rotational motor 700 drives one of the feeding plates 800 to a third position 50 where the feeding plate 800 is positioned above the base 102 and the lengthwise direction of the second connecting plate 704 is substantially perpendicular to the lengthwise direction of the first rail 302 and meanwhile the other feeding plate 800 to a fourth position 60.

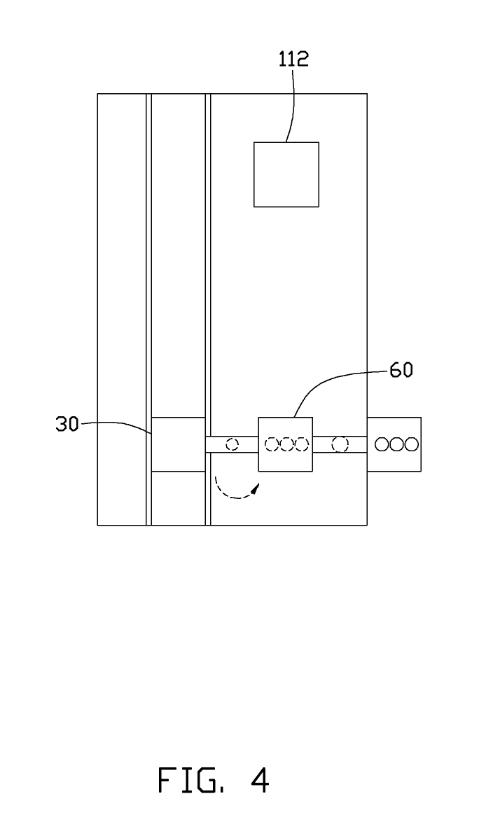

Referring to FIG. 4, the first linear actuator 300 drives the operating plate 500 at the second position 40 to the third position 50. Then, the second linear actuator 400 drives the operating plate 500 at the third position 50 to move to the feeding plate 800 at the third position 50 to press the cylinders 20 and move back. As such, the cylinders 20 are attached to the operating plate 500 at the third position 50 as the molten wax solidifies.

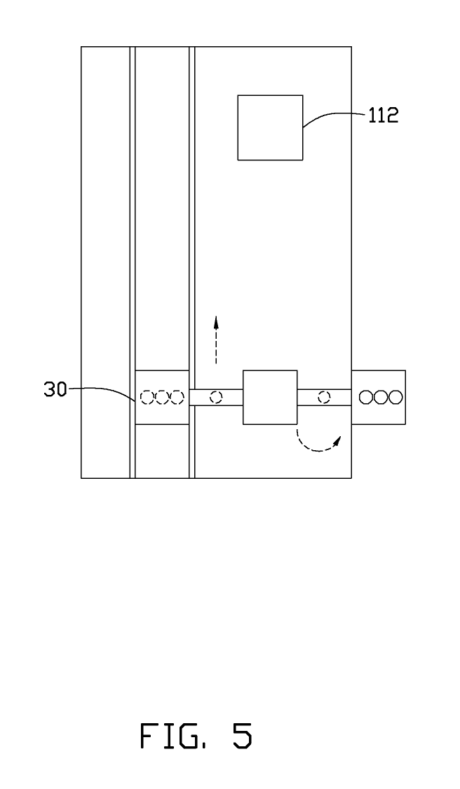

Referring to FIG. 5, then, the first rotational motor 600 rotates to switch the two operating plates 500 between the first position 30 and the third position 50.

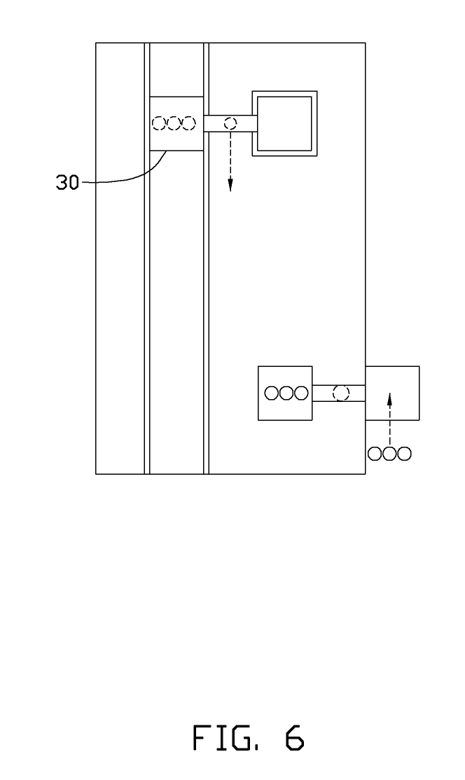

Referring to FIG. 6, the first linear actuator 300 drives the operating plate 500 at the third position 50 to the second position 40. The second rotational motor 700 rotates such that the feeding plate 800 at the third position 50 is moved from the third position 50 to the fourth position 60 and the other feeding plate 800 is moved from the fourth position 60 into the third position 50. Another set of cylinders 20 is placed into the feeding plate 800 at the fourth position 60. Referring to FIG. 6, the second linear actuator 400 corresponding to the operating plate 500 at the second position 40 dip the operating plate 500 at the position 40 into the molten wax and then move the operating plate 500 back.

Referring to FIG. 7, the first linear actuator 300 then drives the operating plates 500 to move along the lengthwise direction of the heating plate 200. At the same time, the second linear actuator 400 corresponding to the operating plate 500 at the first position 30 drives the operating plate 500 to press the cylinders against the heating plate 200 causing the wax to melt and the lenses 22 on the heating plate 200 to separate without or, at least, with reduced human operations.

Referring to FIG. 8, the first linear actuator 300 keeps driving the operating plates 500 until the operating plate 500 from the first position 30 moves to the third position 50. Then, the procedure can go back to the step as shown in FIG. 4. The lenses 22 can be gathered manually or by an automatic gathering device.

In other embodiments, only one of the second linear actuators 400 and the operating plates 500 can be employed. The first rotational motor 600 can be omitted. The second slider 404 can be connected to the first slider 304 directly such that the second rail 402 points to the heating plate 200 directly. The second rotational motor 700 and the feeding plates 800 also can be omitted in other embodiments and the cylinders 20 are fed manually.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. A lens dewaxing device, comprising:
a platform comprising a base and a support positioned on the base;
a heating plate positioned on the base;
a first linear actuator comprising a first rail fixed to the support and a first slider slidably riding on the first rail, the first rail being in parallel with the heating plate, the first linear actuator being configured for driving the first slider to slide on the first rail;
a second linear actuator comprising a second rail and a second slider slidably riding on the second rail, the second slider being connected to the first slider in such a way that the second rail is perpendicular to the heating plate, the second linear actuator being configured for driving the second slider to slide on the second rail such that the second rail moves in a direction substantially perpendicular to the heating plate; and
an operating plate fixed to the second rail at an end far from the first linear actuator and in parallel with the heating plate.

2. The lens dewaxing device of claim 1, wherein the base defines an opening, and the heating plate is placed in the opening.

3. The lens dewaxing device of claim 2, wherein the base and the opening are rectangular, and the lengthwise direction of the opening is substantially parallel to that of the base.

4. The lens dewaxing device of claim 3, wherein the support comprises four vertical rods and two horizontal rods, the four vertical rods are perpendicularly connected to four corners of the base, the base is positioned at one end of the four vertical rods, the two horizontal rods are positioned at the other end of the four vertical rods and parallel to each other, and two ends of each horizontal rod connect two of the vertical rods.

5. The lens dewaxing device of claim 4, wherein the first rail connects central portions of the two horizontal rods, and the lengthwise direction of the heating plate is substantially parallel to that of the first rail.

6. The lens dewaxing device of claim 5, wherein the first linear actuator further comprises two guiding rods connect the two horizontal rods at two sides of the first rail and in parallel with the first rail, the first slider is a rectangular block and the lengthwise direction thereof is substantially perpendicular to that of the first rail, the first slider defines two guiding holes at two lengthwise ends thereof, and the two guiding rods slidably run through the respective guiding holes.

7. The lens dewaxing device of claim 1, wherein the heating plate is made of metal and heated by electric energy.

8. The lens dewaxing device of claim 1, wherein the lens dewaxing device further comprises a first rotational motor, the first rotational motor comprises a connection body connected to the first slider, a first rotor protruding from the connection body along a direction that is substantially perpendicular to the heating plate, and a rectangular first connecting plate with a central portion thereof connecting to an end of the first rotor far from the connection body, the first rotational motor is configured for driving the first rotor to rotate in relative to the connection body, the first connecting plate is substantially parallel to the heating plate, the lens dewaxing device comprises another second linear actuator and another operating plate fixed to the second rail of the another second linear actuator, the second sliders of the two second linear actuators are connected to two lengthwise ends of the first connecting plate.

9. The lens dewaxing device of claim 8, wherein the base defines a groove for storing molten wax, the first rotational motor is configured for switching the two operating plates between a first position where one of the operating plates faces the heating plates directly and a second position where the other operating plate faces the groove directly.

10. The lens dewaxing device of claim 8, wherein the lens dewaxing device further comprises a second rotational motor and two feeding plates, the second rotational motor comprises a second rotor rotationally positioned aside the base and in perpendicular with the base, and a second connecting plate, the second connecting plate is elongated, with a central portion connected to the second rotor and two lengthwise sides connected to the respective feeding plates, the feeding plates are in parallel with the heating plate, the second rotational motor is configured for driving the second rotor to rotate such that the two feeding plate are rotated into a third position in turn, and the first linear actuator is configured for driving the operating plate at the second position to move to the third position.
